(19) United States
(12) Patent Application Publication
(10) Pub. No.: US 2025/0383654 A1
(43) Pub. Date: Dec. 18, 2025

(54) METHOD FOR DETERMINING A CONTROLLER CONFIGURATION FOR A DRIVE SYSTEM, COMPUTER PROGRAM, COMPUTER-READABLE MEDIUM, DEVICE AND DRIVE SYSTEM

(71) Applicant: Siemens Aktiengesellschaft, 80333 München (DE)

(72) Inventors: Bernhard Dirsch, Erlangen (DE); JEROME FLENDER, Wilnsdorf (DE); HARTMUT LINKE, Erlangen (DE); ALEXANDER LOMAKIN, Nümberg (DE); MARKUS SCHULZ, Hamburg (DE); ROLAND ZIMMERMANN, Erlangen (DE)

(73) Assignee: Siemens Aktiengesellschaft, 80333 München (DE)

(21) Appl. No.: 18/878,417

(22) PCT Filed: Jun. 15, 2023
(86) PCT No.: PCT/EP2023/066030

§ 371 Date: Dec. 23, 2024

(30) Foreign Application Priority Data
Jun. 30, 2022 (EP) 22182081.4

(51) Int. Cl. G05B 19/418

(52) U.S. Cl. CPC G05B 19/41885; G05B 19/4183; G05B 2219/23424

(57) ABSTRACT

A controller configuration for a drive system with a drive is determined using at least one simulation model. One or more controlled system measurement results are received. One or the respective controlled system measurement result is obtained by measuring an RPM speed control loop of the drive system. A simulation model with a drive unit submodel and with one or more controlled system submodels is created for the or the respective RPM speed control loop. A system identification is carried out using the or the respective controlled system measurement result in order to obtain the or the respective controlled system submodel. A controller configuration is determined for the drive system using the simulation model.

The Invention relates to a method for determining a controller configuration for a drive system. The invention also relates to a computer program, a computer-readable medium, a device for data processing, and a drive system.

Complex drive systems, such as, for example, printing presses, require specific controller settings for optimal operation on account of the underlying mechanical controlled system behavior. Due to the enormous variability of drive trains, a specialist is often needed to parameterize and optimize the drives. Depending on the complexity of the underlying system, parameterization and commissioning can be very labor-intensive even for specialists.

The existing controller optimization algorithms are often insufficient to fully cover this variability, which is why a specialist has to carry out the analysis and optimization.

In addition, manual optimization requires permanent machine accessibility, as this is an iterative process in which the selected settings are repeatedly checked by measurements. These waiting times and adjustments to the machine result in downtimes for the end customer, as production cannot take place during this time.

As changes also occur in the system, a common issue is that the controlled system behavior must be continuously monitored during operation and the current controller configuration adjusted accordingly. Thus, a one-time optimization at commissioning is insufficient for many situations and applications and requires more time and effort.

In addition, finding a suitable common controller setting for similar drive systems poses a particular challenge. For example, different load configurations can arise as a result of runtime, aging, or retooling. The controller settings must then be re-checked by a specialist in each case and adjusted if necessary, which is time-consuming. It would be desirable to determine a suitable controller configuration applicable across multiple drive systems that does not need continual adjustment in response to changes, especially at the individual axes. Using expert knowledge, it may sometimes be possible to find a controller configuration that works for different load configurations. However, the necessary validation of the setting is very laborious, as testing must be performed for all load configurations.

In many applications, system changes can also occur multiple times per day. Depending on the final product, load inertia or other system parameters (stiffness, damping) may change, which in turn poses a challenge to the existing control system. This significantly increases complexity, and there is a lack of specific guiding rules for configuring a controller, leaving the setup engineer reliant solely on experience and intuition.

Previous approaches often only partially solve problems during commissioning and also require expert know-how.

The applicant is aware of a method in which a machine is analyzed using an automatic controller optimization algorithm by measuring the RPM speed control loop and using this to optimize the controller settings and apply them directly in the drive. This requires a connection to the actual machine, resulting in idle periods and therefore downtime.

It is also known to use simulations for controller optimization. This involves creating a model of the corresponding machine, which assumes that the essential mechanical properties and parameters are known. Expert knowledge is required here.

EP 3 518 051 A1 discloses a method for determining a strategy for optimizing the operation of a processing machine. No optimization as such is carried out. This remains the user's responsibility. However, the user is provided with information as to which parameters need to be varied in order to optimize the operation of the machine and what the user must be aware of during optimization.

EP 3 451 100 A1 describes an operating method for a machine. This comprises a normal and a special mode. In the latter, a control device of the machine acquires actual values resulting from setpoint values and determines a frequency characteristic of an actuator based on the sequence of setpoint values specified in special mode and associated actual values acquired. Using the frequency characteristic and parameters of the controller structure, the control device determines an assessment for the actuator and/or the controller structure and, depending on the assessment, decides whether and, if so, which message it transmits to an operator of the machine or via a computer network to a computing device. The method provides a simple and reliable means of early detection of problematic machine states.

EP 2 690 513 B1 discloses a method for condition monitoring of a program-controlled machine. This involves providing a dynamic model of the machine or part thereof, wherein the dynamic model comprises model parameters such as mass inertias, spring stiffnesses or damping values, and performing a frequency analysis for the machine or part thereof. Based on the frequency analysis, at least one new value for at least one model parameter is determined and the new value is compared with the original value. The machine's state is determined on the basis of the comparison result.

US 2008/183311 A1 discloses a system, a method and a computer program for automated closed-loop identification of an industrial process in a process control system.

EP 2 835 227 A1 describes a robot control apparatus for controlling a robot arm having an elastic mechanism between a rotation axis of a motor and a rotation axis of a link.

EP 3 349 078 A1 describes a diagnostic device and a method for monitoring and/or optimizing a control device.

DE 197 57 715 A1 discloses a method for the automatic adjustment of the speed controller in the case of elastomechanical controlled systems.

Proceeding from the prior art, an object of the present invention is to provide a method for determining a controller configuration that is comparatively simple to carry out, requires minimal expert knowledge, has little effect on the normal operation of the drive system and allows controller optimization even in the case of different load configurations.

This object is achieved by the method as claimed in claim 1. Disclosed is a method using at least one simulation model to determine a controller configuration for a drive system comprising a drive, wherein
S1) one or more controlled system measurement results are received, wherein the or the respective controlled system measurement result is or was obtained by measuring an RPM speed control loop of the drive system, preferably wherein the or the respective controlled system measurement result is constituted by or comprises at least one metrologically acquired frequency response of the or the respective RPM speed control loop,
S2) a simulation model with a drive submodel and with one or more controlled system submodels is created for the or the respective RPM speed control loop, wherein a system identification is carried out using the or the respective controlled system measurement result to obtain the or the respective controlled system submodel, and
S3) a controller configuration for the drive system is determined using the simulation model.

In other words, the method according to the invention provides defined controller optimization of a drive system, taking into account measurements and setting criteria based solely on at least one specific real measurement on the drive system. A digital representation of the drive and the RPM speed control loop(s) is created and used as a dynamic simulation model, which then enables an optimized controller configuration to be determined. The inventively employed simulation model comprises a drive submodel and one or more controlled system submodels. The controlled system submodel, or—in the case of a plurality of controlled system measurement results—the controlled system submodels, replicate the mechanics and the mechanical behavior. According to the invention, the controlled system submodel or the controlled system submodels are determined on the basis of a generic system identification. The basis for this is the real measurement or real measurements of the RPM speed control loop(s). Combined with the digital representation of the drive, this produces a dynamic model that can provide an optimum basis for further tuning of the control parameters. Based on the detailed stored simulation model, highly precise simulations can be created, thus ensuring reliable optimization of the controller configuration. In step S3, the controller parameters can be optimized on the basis of the mathematical models determined in respect of the user-specified criteria and then simulated and verified using the simulation model, in particular with the use of discrete control loops, which is a preferred approach. Examples of possible criteria would be amplitude overshoots as well as amplitude and phase margins.

The method according to the invention offers further advantages over and above higher accuracy as compared to conventional methods. Downtime for commissioning a real machine can be significantly reduced, as virtual modelling and simulation of the identified controlled system(s) is possible based on a verified simulation model. Controller settings can be tested on the (respective) identical, virtual controlled system submodel without having to interfere with operation. Access to the real drive system is not required in order to carry out the method according to the invention. It is merely necessary to perform the at least one real measurement of the RPM speed control loop(s) to obtain the (respective) controlled system measurement result, which can also be done beforehand. The method according to the invention can be carried out practically at any time and independently of normal operation of the drive system. It can also be performed without access to or intervention affecting the drive system.

Particularly if the method according to the invention is integrated into an edge environment, the controller configuration can also be optimized continuously, preferably on an ongoing basis. A user will be able to perform optimization independently, without expert knowledge. The current controller configuration can also be checked and adjusted to reflect given changes in the drive system during normal operation, wherein new measurements of the (respective) RPM speed control loop(s) can be taken at regular intervals or at intervals specified by the user. Corresponding measurement phases can be incorporated or supplemented in the respective operating phase.

The method according to the invention is also very universally applicable. It is not limited to or focused on specific machine types.

For the first time it is also possible to combine a plurality of models and measurements for a controller setting using e.g. modified tools and/or other modified system parameters. Accordingly, the inventive method has also proved to be particularly suitable for determining an optimized common controller configuration for different load configurations which can arise, for example, as a result of retooling processes. In accordance with the invention, it is therefore provided that in step S1 a plurality of controlled system measurement results associated with different RPM speed control loops are received, and in step S2 a simulation model is created with a respective controlled system submodel for each of the RPM speed control loops, and in step S3 a common controller configuration suitable for all the RPM speed control loops is determined using the simulation model comprising the plurality of controlled system submodels.

The controlled system measurement result(s) can, for example, be provided or received by an engineering system or an engineering platform. It is also possible for the measurement(s) of the respective RPM speed control loop to be performed using an engineering system or engineering platform in order to obtain the respective controlled system measurement result(s).

The frequency characteristics of all the individual RPM speed control loops are preferably superimposed in order to determine an envelope curve and, on this basis, to determine a stable controller configuration as a common controller configuration for all systems.

The various RPM speed control loops for which the plurality of controlled system measurement results are provided are designed differently. In particular, they can differ in respect of at least one component. It is possible, for example, that modifications to the real drive system due to retooling are to be expected. Merely by way of example, a printing press is to be operated with different rollers, in particular rollers of different sizes. In this case, the method according to the invention can be used to find an optimized, common controller configuration that is suitable for all roller sizes. The time and effort involved in finding a comprehensive controller configuration is comparatively low. Time-consuming reparameterization of the controller in a retooling situation is also no longer necessary.

Another advantageous embodiment is characterized in that the respective controlled system measurement result is or was obtained by measuring the respective RPM speed control loop after a defined excitation, in particular after a defined noise excitation, preferably after a pseudo-random noise excitation. This approach has proved to be particularly suitable.

Alternatively or in addition, it can be provided that, for system identification, a number of poles and zeros is defined for the or the respective controlled system measurement result, and/or that a number of poles and zeros is determined in the or the respective controlled system measurement result. This can be done e.g. by a user or automatically.

System identification for the or the respective controlled system submodel can also include providing a controlled system submodel with unknown model parameters and determining the model parameters using the or the respective controlled system measurement result, preferably via a mathematical approximation to the measured curve. A mathematical optimization method can be used to approximate the model characteristics so that it corresponds to the or the respective controlled system measurement result, in particular according to a quality criterion defined by the user. Mentioned merely by way of example would be a controlled system submodel for a multi-mass oscillator, in particular a two-mass oscillator, with the unknown parameters to be optimized being the inertias, stiffness, and damping. The optimization can be carried out using a numerical optimization algorithm that minimizes the deviation between the (respective) controlled system measurement result, in particular the (respective) measured frequency response characteristic, and the characteristic to be set by the parameters (e.g. a Nelder-Mead algorithm).

System identification for the or the respective controlled system submodel can also include iterative adjustment of the model parameters, in particular until a desired result is obtained, which is carried out until the quality criteria defined by the user are met or the adjustable maximum number of iterations is reached.

In a further embodiment of the invention, the drive submodel is created, in particular as a representation of the control and regulation of the converter, using known drive parameters, preferably using known motor parameters of a motor in the drive. For example, corresponding information can be provided, retrieved, or received from an engineering system or an engineering platform. The drive submodel preferably replicates the behavior necessary for the control and regulation of the converter so that the torque values match the speeds. The drive submodel is advantageously implemented and parameterized in an identical manner to the real drive. The time characteristics of the controller cascade structure and all the filters involved are advantageously also re-implemented analogously to the real model.

The controller configuration determined in step S3 can comprise, in a manner known in principle, controller parameters and current setpoint filters for the drive system, in particular for the drive.

Advantageously, the controller configuration is transferred to the real drive system and this is controlled accordingly. It can also be transferred to an engineering system or engineering platform.

Another object of the present invention is a computer program comprising program code means which, when executed on at least one computer, causes the at least one computer to carry out the steps of the method according to the invention.

The invention also relates to a computer-readable medium comprising instructions which, when executed on at least one computer, cause the at least one computer to carry out the steps of the method according to the invention.

The computer-readable medium can be e.g. a CD-ROM or DVD or a USB or flash memory. It should be noted that a computer-readable medium is not to be understood as being exclusively a physical medium, but can also be provided, for example, in the form of a data stream and/or a signal representing a data stream.

The invention also relates to a device for data processing, comprising
a processor, and
a data storage device on which computer-executable program code is stored which, when executed by the processor, causes the processor to carry out the steps of the method according to the invention.

In an advantageous further development, the device is designed as an edge device.

The object of the invention is lastly to provide a drive system which is designed and set up to carry out the method according to the invention. The drive system comprises a data processing device according to the invention.

Further features and advantages of the present invention will emerge from the following description of an embodiment according to the invention with reference to the accompanying drawing in which:

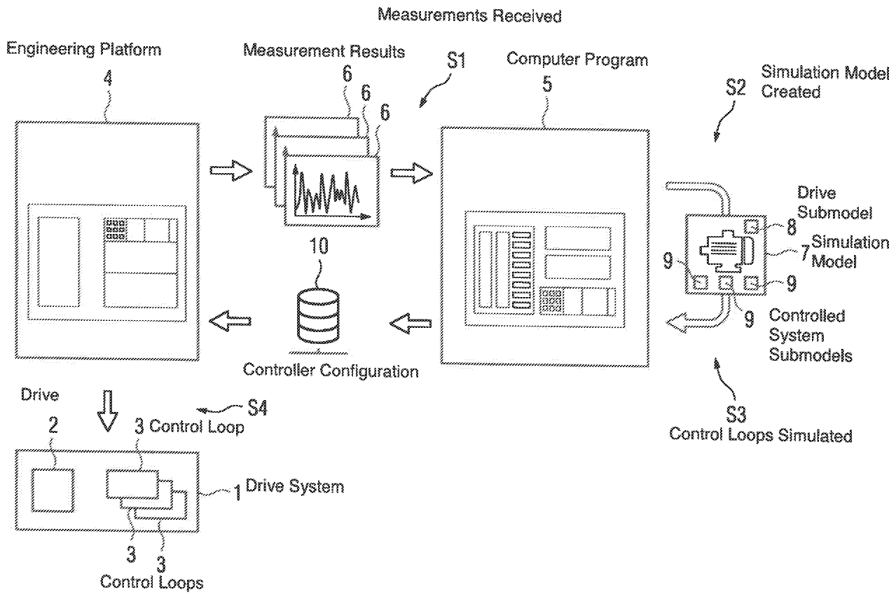

FIG. 1 is a purely schematic representation of the steps of an exemplary embodiment of the method according to the invention

FIG. 1 shows a purely schematic block diagram of a real drive system 1 with a drive 2. Also shown are three real RPM speed control loops 3 of the drive system 1 which are different from one another, specifically corresponding to three different load configurations. For example, the first RPM speed control loop 3 can correspond to an initial state at commissioning, and the two other configurations can each correspond to changed configurations as a result of, for example, retooling operations. Merely by way of example, a printing press comprising the drive system 1 is operated with three different rollers.

It should be emphasized that the number of three RPM speed control loops 3 is to be understood as purely exemplary and that it could be any given number, even a single RPM speed control loop 3.

FIG. 1 also shows an engineering platform 4 connected to the drive system 1 and a computer program 5 comprising program code means which, when executed on at least one computer, cause the at least one computer to carry out the steps described below, as also schematically illustrated in the FIGURE. The drive system 1 can comprise a device for data processing, comprising a processor and a data storage device on which corresponding computer-executable program code is stored which, when executed by the processor, causes the processor to carry out the steps described. However, such a device can also be separate from the drive system 1. For example, it can also be an edge device.

In step S1, a plurality of controlled system measurement results 6, in this case three, are received by the computer program 5 for the three RPM speed control loops 3, each of said results being obtained by measuring one of the three RPM speed control loops 3 of the drive system 1 after a defined noise excitation, in this case after a pseudo-random noise excitation. A user can import the controlled system measurement results 6 from the engineering portal 4, for example. The controlled system measurement results 6 are each representative of a metrologically acquired frequency response of the respective RPM speed control loop 3. In the present case, the frequency responses 6 have been recorded prior to step S1 using the engineering platform 4 which comprises an associated functionality in a manner known in principle. In the exemplary embodiment described here, the frequency responses 6 constituting the controlled system measurement results were recorded beforehand, in other words before the method was carried out. The steps described here can be performed completely independently of the operation of the drive system 1 and without access thereto.

In step S2, a simulation model 7 is created, comprising a drive submodel 8 and a plurality of, in this case three, controlled system submodels 9. Each controlled system submodel 9 corresponds to one of the RPM speed control loops 3. To obtain the controlled system submodels 9, a generic system identification is carried out using the respective controlled system measurement result 6. The user defines the number of poles and zeros (model complexity) that they expect for the respective RPM speed control loop 3. The system identification is then carried out. First, a controlled system submodel with unknown model parameters is provided for each RPM speed control loop 3 and the model parameters are determined using the respective controlled system measurement result 6. For this purpose, the corresponding model parameters are adjusted using a numerical optimization algorithm until the curves of the frequency characteristics of the controlled system measured match as closely as possible the one modelled or meet quality criteria specified by the user.

As soon as the RPM speed control loops 3, in other words the mechanical systems and the mechanical behavior, have been identified, motor data such as motor type, pole pair count and motor constants for the drive 2 are transferred from the engineering platform 4 or manually by the user and an associated drive submodel 8 is created, in particular as a representation of the control and regulation of the converter using known drive parameters. The drive submodel 8 and its parameterization are advantageously implemented in an identical manner to the real drive. In this process, the time characteristics of the controller cascade and all the filters involved are preferably also re-implemented analogously to the real model.

In step S3, discrete control loops are simulated and verified using the simulation model 7 incorporating the drive submodel 8 and the controlled system submodels 9, and a suitable controller configuration 10 for the drive system 1 is determined. The frequency characteristics of the open and closed control loops of the optimized system are presented for validation by the user following optimization. The optimized system refers specifically to the overall system comprising the drive 2 and controlled system(s) 3 after optimization of the controller parameters. The optimized parameters have preferably been incorporated into the drive submodel 8 and the optimized system re-simulated. Simulations within the simulation model 7 can be implemented with the respective previously identified controlled system submodels 9 in order to verify the time response of the optimized system for different application-oriented situations and applications. For example, step responses or setpoint profiles from the real control system can be simulated.

An averaged controller configuration 10 that is stable across all three RPM speed control loops 3 is generated as a common controller configuration 10. The common controller configuration 10 comprises filter and controller settings that can govern all three RPM speed control loops 3 uniformly and provide optimized system behavior. If, for example, a different RPM speed control loop 3 is acquired due to retooling, no re-parameterization is required. The single controller configuration remains suitable.

The common controller configuration 10 can be transferred to the engineering platform 4, as indicated by an arrow in FIG. 1.

In step S4, the determined controller configuration 10 is transferred to the drive system 1 and the latter is controlled accordingly. As a result, an optimized system behavior is achieved for all three RPM speed control loops 3.

By carrying out the described procedure, downtimes for commissioning a real machine can be significantly reduced, as a virtual design and simulation of the identified controlled system(s) is possible based on a verified simulation model 7. A high level of accuracy is achieved, and this without having to intervene in operation.

Although the invention has been illustrated and described in detail by the preferred exemplary embodiment, the invention is not limited by the examples disclosed and other variations will be apparent to a person skilled in the art without departing from the scope of protection sought for the invention.

What is claimed is:

1.-15. (canceled)

16. A method for determining a controller configuration for a drive system with a drive using at least one simulation model, the method comprising:
obtaining a plurality of controlled system measurement results associated with different RPM speed control loops, which differ in respect of at least one component and are of different design, by measuring the RPM speed control loops of the drive system;
receiving the one or more controlled system measurement results;
carrying out a system identification in order to obtain controlled system submodels using the controlled system measurement results by providing a controlled system submodel with unknown model parameters and determining the model parameters using the controlled system measurement results and using a mathematical optimization method to approximate the model parameters so that the model parameters correspond to the controlled system measurement results;
creating a simulation model with a drive submodel and with a controlled system submodel created for each of the RPM speed control loops; and
determining an averaged controller configuration as a common controller configuration for the drive system using the simulation model, the common controller configuration suitable for all of the RPM speed control loops and stable for all of the RPM speed control loops.

17. The method of claim 16, wherein the controlled system measurement results comprise at least one metrologically acquired frequency response of the RPM speed control loops.

18. The method of claim 16, wherein the mathematical optimization to approximate the model parameters is according to a quality criterion defined by the user.

19. The method of claim 16, further comprising obtaining controlled system measurement results by measuring the RPM speed control loop after a defined excitation.

20. The method of claim 19, wherein the defined excitation is a defined noise excitation, preferably after a pseudo-random noise excitation.

21. The method of claim 20, wherein the defined noise excitation is a pseudo-random noise excitation.

22. The method of the claim 16, further comprising defining, for the system identification, a number of poles and zeros for the or the controlled system measurement results, and/or determining a number of poles and zeros in the controlled system measurement results.

23. The method of the claim 16, further comprising iteratively adjusting the model parameters in the system identification for controlled system submodels.

24. The method of claim 23, further comprising iteratively adjusting the model parameters until a desired result is obtained.

25. The method of claim 16, further comprising creating the drive submodel using known drive parameters.

26. The method of claim 16, further comprising creating the drive submodel using known drive parameters of a motor of the drive.

27. The method of claim 16, further comprising determining the controller configuration for a drive system with a drive using at least one simulation model independently of the operation of the drive system, and/or without access to the drive system.

28. The method of claim 16, further comprising simulating and verifying discrete control loops using the simulation model in determining the averaged controller configuration.

29. The method of claim 16, further comprising controller parameters and current setpoint filters for the drive system comprising the determined averaged controller configuration and/or transferring the determined controller configuration to the drive system and controlling the drive system accordingly.

30. The method of claim 16, further comprising controller parameters and current setpoint filters for the drive comprising the determined averaged controller configuration.

31. A non-transitory computer-readable medium storing a computer program comprising instructions which, when executed on at least one computer, cause the at least one computer to carry out the method of claim 16.

32. A device for data processing, the device comprising:
a processor; and
a data storage device on which computer-executable program code is stored which, when executed by the processor, causes the processor to carry out the method of claim 16.

33. A drive system, comprising:
a drive; and
a device for data processing the device comprising a processor, and a data storage device on which computer-executable program code is stored which, when executed by the processor, causes the processor to carry out the method of claim 16.
